(19) United States
(12) Patent Application Publication
(10) Pub. No.: US 2024/0166044 A1
(43) Pub. Date: May 23, 2024

(54) Actuation Device for a Motor Vehicle, Motor Vehicle

(71) Applicant: Robert Bosch GmbH, Stuttgart (DE)

(72) Inventors: Martin Baeuml, Weitnau (DE); Guenter Escher, Oberstdorf (DE); Andreas Baumgartner, Auenstein (DE); Juergen Kissner, Oppenweiler (DE); Manfred Fischer, Oppenweiler (DE); Timo Knecht, Mundelsheim (DE)

(21) Appl. No.: 18/507,679

(22) Filed: Nov. 13, 2023

(30) Foreign Application Priority Data
Nov. 22, 2022 (DE) 10 2022 212 429.4

(51) Int. Cl. B60K 26/02; B60T 7/04

(52) U.S. Cl. CPC B60K 26/02; B60T 7/042

(57) ABSTRACT

An actuation device for a motor vehicle, in particular for specifying a braking and/or acceleration request, includes a first housing portion which is slidably mounted on a second housing portion in a vertical extension of the second housing portion. The first housing portion includes an actuating surface on a top surface facing away from the second housing portion, or a cover having the actuating surface is arranged on the top surface. The first housing portion includes a bar-shaped projection on an inner side facing the second housing portion. Further, the second housing portion includes a guide receptacle for the projection for the guided, slidable mounting of the first housing portion on the second housing portion.

This application claims priority under 35 U.S.C. § 119 to patent application no. DE 10 2022 212 429.4, filed on Nov. 22, 2022 in Germany, the disclosure of which is incorporated herein by reference in its entirety.

The disclosure relates to an actuation device for a motor vehicle, in particular for specifying a braking and/or acceleration request.

In addition, the disclosure relates to a motor vehicle having at least one such actuation device.

### BACKGROUND

It is known from the prior art to detect an actuation of an actuation device for a motor vehicle which can be actuated by a driver using a sensor assigned to the actuation device. If the driver actuates the actuation device, a braking or acceleration request of the driver is in particular detected as a function thereof. For example, brake systems with electromechanical brake amplifiers are known that, together with a vehicle assistance system, in particular an electronic stability program (ESP), form a redundant brake-by-wire system, in which there is no mechanical connection between the actuation device and the brake system. A braking request is, e.g., transmitted as a function of an actuation of the actuation device to an electromechanical actuator, which is designed to perform a pressure build-up in the braking system. Similar actuation devices for drive units, in particular having internal combustion engines and/or electric motors, are known from motor vehicles which are part of a drive-by-wire system without a mechanical connection to the drive unit. For example, an acceleration request is detected as a function of an actuation of the actuation device and transmitted to the drive unit. Given the lack of mechanical coupling between the actuation devices and the brake system and/or the drive unit, it is possible to design such actuation devices to be are stroke-free or to feature at least a short stroke of a few millimeters. The use of various measurement methods for detecting the actuation is known. For example, disclosure documents DE 10 2017 119 392 A1, DE 102 39 913 A1, and DE 103 12 547 A1 each disclose stroke-free pedals, as well as the detection of an actuation of a stroke-free pedal by means of strain gages.

### SUMMARY

The actuation device according to the disclosure is characterized in that it comprises a first and a second housing portion, that the first housing portion is slidably mounted on the second housing portion in vertical extension of the second housing portion, that the first housing portion comprises an actuation surface on a top side facing away from the second housing portion, or in that a cover having the actuation surface being arranged on the top side, the first housing portion having a bar-shaped projection on an inner side facing the second housing portion, and the second housing portion comprising a guide receptacle for the projection for guided slidable mounting of the first housing portion on the second housing portion. The bar-shaped projection, in conjunction with the guide receptacle, ensures particularly advantageous mounting of a low-stroke actuation device, as described hereinabove. Particularly preferably, at least one electrical component of a sensor arrangement for detecting an actuation of the actuation device, in particular for detecting an actuating force exerted on the actuating surface, is arranged in the second housing portion, in particular in a region of the second housing portion associated with the projection. The projection is preferably arranged at least approximately centrally on the first housing portion in transverse extension and/or longitudinal extension. In particular, the projection is at the same distance from each of two outer edges of the first housing portion, which are arranged opposite one another.

According to one preferred embodiment of the disclosure, it is provided that the projection features a circular cross-section. The circular cross-section advantageously ensures that the projection is particularly easily received in the guide receptacle. When the housing portions are joined, this allows the housing portions to be rotated relative to one another, in particular at first.

It is particularly preferred that the projection features a cross-section that deviates from a circular shape, in particular oval or polygonal. The cross-section, which deviates from the circular shape, has the advantage that the projection together with the guide receptacle form an additional anti-rotation feature for the two housing portions relative to each other.

According to one preferred embodiment of the disclosure, it is provided that the projection is designed as a cylinder, in particular a hollow cylinder. The design as a cylinder creates a particularly advantageous possibility for arranging further components within and/or outside the projection. In addition, the projection is advantageously easy to manufacture.

It is particularly preferably provided that a sliding bearing element is arranged within the projection or between the projection and the guide receptacle. The sliding bearing element advantageously ensures that the two housing portions are guided together in a low-wear manner. In particular, the sliding bearing element is designed as a sliding bearing with solid state friction, for example it comprises a material alloyed with lead or tin, a plastic such as PTFE, POM, as well as other plastics featuring a low friction level and high wear resistance, or a technical ceramic.

According to a preferred embodiment of the disclosure, it is provided that at least one spring element, in particular a coil spring, is arranged as a return spring between the housing portions. The spring element advantageously ensures that the first housing portion returns to a predetermined initial position in an unactuated state.

It is particularly preferably provided that the spring element is arranged within the projection. The advantage thereby is that the spring element is guided axially and securely within the projection.

According to one preferred embodiment of the disclosure, it is provided that the spring element is arranged outside the projection, in particular at least two spring elements being arranged diametrically opposite to each other and at a distance from the projection. Given such an arrangement of the spring element, the geometrical design of the projection is advantageously independent of a geometry of the spring element. A particularly advantageously uniform return is provided by at least two diametrically opposite spring elements. A plurality of spring elements, in particular four spring elements, is preferably arranged outside of the projection, two of the spring elements each being arranged diametrically opposite to each other and at a distance from the projection, and/or the spring elements being arranged in an evenly distributed manner around a longitudinal central axis of the projection.

It is particularly preferred that the first housing portion comprises at least one further projection at a distance from the projection and that the second housing portion comprises a further guide receptacle in which the further projection can be arranged or is arranged at least in regions as an anti-rotation feature. The further projection results in the advantage that an anti-rotation feature is created outside the projection with the guide receptacle, and its geometry itself does not have to be anti-rotational. A maximum stroke of the housing portions arts relative to each other is advantageously defined as a function of a depth of the guide receptacle. Particularly preferably, at least two further projections are arranged diametrically opposite to each other and at a distance from the projection.

According to a preferred embodiment of the disclosure, it is provided that the projection comprises a circumferential collar at the end as a stop for limiting the stroke. The collar advantageously ensures that the first housing portion does not unintentionally detach from the second housing portion, and the two housing portions are securely guided together at all times.

It is particularly preferably provided that the collar is designed to be integral with the projection or is connected to the projection in an interlocking, frictional, and/or bonded manner. The integral design of the collar results in the advantage that it is manufactured without an additional step in the assembly of the actuation device. The interlocking, frictional, and/or bonded connection provides a particularly advantageous option for the flexible production of the collar, in particular its geometry.

According to one preferred embodiment of the disclosure, it is provided that an illumination device, in particular a light emitting diode, is arranged in a region of the second housing portion associated with the projection. The illumination device provides a particularly advantageous option for providing visual feedback to a user about an actuation of the actuation device. The illumination device is preferably designed to be controlled together with ambient lighting of the motor vehicle. For example, the illumination device is turned on when the driver enters and/or exits the vehicle, and/or turned off when driving. Alternatively, a lighting intensity or color of the illumination device is defined as a function of an actuation force applied to the actuation surface. In particular, brake and acceleration requests are associated with different light colors.

It is particularly preferred that at least one electrical component of a sensor arrangement for detecting an actuating force exerted on the actuating surface be arranged in said region, and that the component and the illumination device be arranged on a common printed circuit board. The arrangement on a common printed circuit board results in the advantage that electrical contacting is ensured without additional electrical lines. The printed circuit board, which comprises the component and the illumination device, is advantageously insertable into the second housing portion as a preassembled unit.

According to one preferred embodiment of the disclosure, it is provided that a light guiding element for the illumination device be arranged within the projection, which extends from the illumination device through the projection to an opening in the actuating surface. The light guiding element advantageously ensures that a beam of light emanating from the illumination device can be reliably detected on the actuating surface.

The motor vehicle according to the disclosure is characterized by at least one actuation device according to the disclosure. The advantages previously specified are also provided as a result.

### BRIEF DESCRIPTION OF THE DRAWINGS

Further preferred features and feature combinations result from what has been described hereinabove and from the claims. The disclosure is explained in more detail below with reference to the drawings. Shown are:

FIG. 1 a first exemplary embodiment of the actuation device,

FIG. 2 a second exemplary embodiment of the actuation device, and

FIG. 3 a sectional view of the first exemplary embodiment.

### DETAILED DESCRIPTION

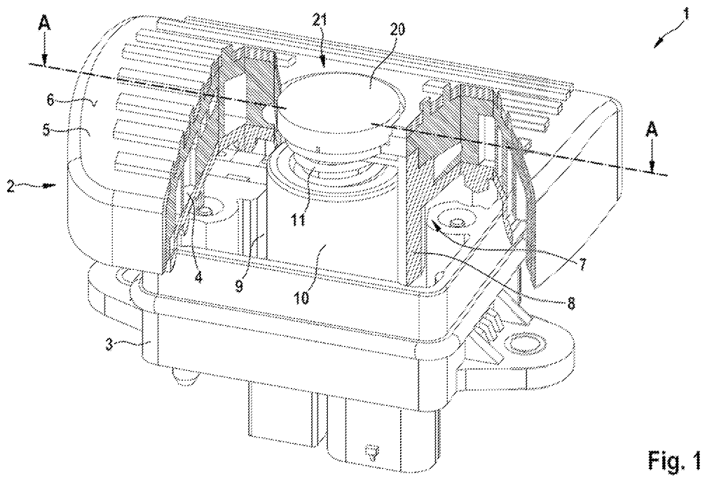

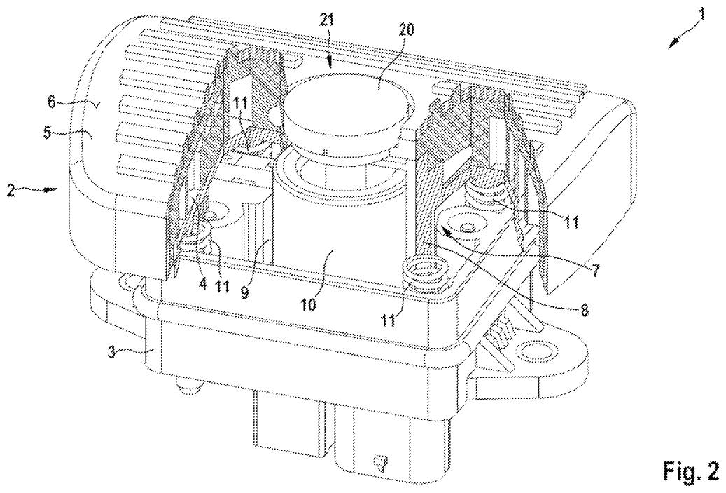

FIGS. 1 and 2 each show a first and a second exemplary embodiment of an actuation device 1 for a motor vehicle (not shown). The actuation device 1 is in particular designed to specify a braking and/or an acceleration request, and can in particular be arranged or is arranged in the footwell of the motor vehicle.

The actuation device 1 comprises a first housing portion 2 and a second housing portion 3. The first housing portion 2 is slidably mounted on the second housing portion 3 in a vertical extension of the second housing portion 3. In order to be able to represent the inner workings of the actuation device 1, the first housing portion 2 is shown cut away.

In the present case, the first housing portion 2 comprises a cover 5 with an actuating surface 6 on a top side 4 facing away from the second housing portion 3. Alternatively, the first housing portion 2 comprises the actuating surface 6 directly on the upper side 4, in particular it is designed to be integral therewith.

The first housing portion 2 further comprises a bar-shaped projection 8 on an inner side 7 facing the second housing portion 3. The second housing portion 3 comprises a guide receptacle 9 for the projection 8 for the guided, slidable mounting of the first housing portion 2 on the second housing portion 3.

In the present case, the projection 8 features a circular cross-section and is designed as a hollow cylinder. A sliding bearing element 10 is arranged within the projection 8.

In addition, at least one spring element 11, in the present case designed as a coil spring, is arranged as a return spring between the housing portions 2, 3. In FIG. 1, the spring element 11 is arranged within the projection 8. In FIG. 2, four such spring elements 11 are arranged outside the projection 8. Two of these four spring elements 11 are each arranged diametrically opposite to each other and at a distance from the projection 8.

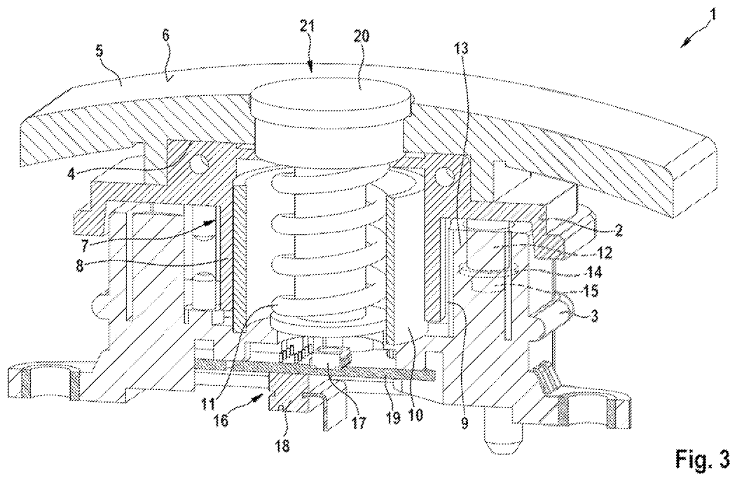

In FIG. 3, which depicts a sectional view of the first exemplary embodiment in FIG. 1 by a sectional plane A-A indicated in FIG. 1, it can further be seen that the first housing portion 2 comprises at least one further projection 12 at a distance from the projection 8. The second housing portion 3 comprises a further guide receptacle 13, in which the further projection 12 is arranged at least in regions as an anti-rotation feature. In particular, two further projections 12 are provided that are diametrically opposite to each other and are arranged at a distance from the projection 8.

The projection 12 comprises a circumferential collar 14 on one side as a stop for limiting the stroke. In the present case, the collar 14 is connected to the projection 12 by a screw 15 in an interlocking, frictional, and/or bonded manner, or is formed by a pin 15 having an embossed head, which is pressed into the projection 12. Alternatively, the collar 14 is designed to be integral with the projection 12. The collar 14 is designed to abut an upper end of the guide receptacle 13 in order to prevent the first housing portion 2 from unintentionally detaching from the second housing portion 3.

An illumination device 17, in the present case in the form of a light emitting diode, is arranged in a region 16 of the second housing portion 3 associated with the projection 8. At least one electrical component 18 of a sensor arrangement is further arranged in the region 16 for detecting an actuation force exerted on the actuation surface. The component 18 and the illumination device 17 are arranged on a common printed circuit board 19, so they are particularly advantageously electrically contacted in a simple manner.

Finally, a light guiding element 20 for the illumination device 10 is arranged within the projection 8 and the spring element 11, which extends from the illumination device 17 through the projection 8 and the spring element 11 to an opening 21 in the actuating surface 6. The illumination device 10 is designed as a light emitting diode, in particular monochrome, or comprises an RGB control.

What is claimed is:

1. An actuation device for a motor vehicle for specifying a braking and/or acceleration request, comprising:
a first housing portion; and
a second housing portion that includes a vertical extension portion,
wherein the first housing porting is slidably mounted on the second housing portion in the vertical extension,
wherein the first housing portion includes an actuating surface on a top surface facing away from the second housing portion, or wherein a cover having the actuating surface is arranged on the top surface,
wherein the first housing portion includes a bar-shaped projection on an inner side facing the second housing portion, and
wherein the second housing portion includes a guide receptacle for the projection for the guided, slidable mounting of the first housing portion on the second housing portion.

2. The actuation device according to claim 1, wherein the projection features a circular cross-section.

3. The actuation device according to claim 1, wherein the projection features a cross-section that deviates from a circular shape.

4. The actuation device according to claim 1, wherein the projection is designed as a cylinder.

5. The actuation device according to claim 1, further comprising a sliding bearing element arranged within the projection or between the projection and the guide receptacle.

6. The actuation device according to claim 1, further comprising at least one spring element arranged between the housing portions as a return spring.

7. The actuation device according to claim 6, wherein the at least one spring element is arranged within the projection.

8. The actuation device according to claim 6, wherein the at least one spring element is arranged outside of the projection.

9. The actuation device according to claim 1, wherein:
the first housing portion includes at least one further projection at a distance from the projection, and
the second housing portion includes a further guide receptacle in which the further projection is arranged.

10. The actuation device according to claim 9, wherein the projection includes a circumferential collar at the end which is configured as a stop for limiting the stroke.

11. The actuation device according to claim 10, wherein the collar is designed to be integral with the projection, or is connected to the projection in an interlocking, frictional, and/or bonded manner.

12. The actuation device according to claim 1, further comprising an illumination device arranged in a region of the second housing portion associated with the projection.

13. The actuation device according to claim 12, further comprising at least one electrical component of a sensor arrangement which is configured to detect an actuating force exerted on the actuating surface,
wherein the at least one electrical component of the sensor arrangement is arranged in the region of the second housing portion associated with the projection, and
the at least one electrical component of the sensor arrangement and the illumination device are arranged on a common printed circuit board.

14. The actuation device according to claim 12, further comprising a light guiding element for the illumination device,
wherein the light guiding element is arranged within the projection, and
wherein the light guiding element extends from the illumination device through the projection and into an opening in the actuating surface.

15. A motor vehicle, comprising at least one actuation device according to claim 1.

16. The actuation device according to claim 3, wherein the cross-section is oval or polygonal.

17. The actuation device according to claim 1, wherein the projection is designed as a hollow cylinder.

18. The actuation device according to claim 1, wherein the at least one spring element includes at least one coil spring.

19. The actuation device according to claim 6, wherein the at least one spring element includes two spring elements arranged diametrically opposite to each other and at a distance from the projection.

20. The actuation device according to claim 1, wherein:
the first housing portion includes at least one further projection at a distance from the projection, and
the second housing portion includes a further guide receptacle in which the further projection is arranged at least in regions as an anti-rotation feature.
